(19) United States
(12) Patent Application Publication
(10) Pub. No.: US 2007/0208886 A1
(43) Pub. Date: Sep. 6, 2007

(54) Data processing apparatus

(75) Inventor: Takahiro Minami, Yamato-Koriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/647,446

(22) Filed: Dec. 29, 2006

(30) Foreign Application Priority Data
Feb. 22, 2006 (JP) 2006-044846

(51) Int. Cl. G06F 13/28

(52) U.S. Cl. 710/22

(57) ABSTRACT

A DMA-mode data processing apparatus is provided which enables high-speed data processing and efficient use of a memory bus. For DMA circuits that perform at least one of data write into a memory and data read from a memory, a switch SW is disposed which is operated in accordance with an instruction of a CPU, and memory data lines and command signal lines of a first DMA circuit and a second DMA circuit can be connected through lines based on the instruction of the CPU. As a result, while one DMA circuit performs the data write into the memory or the data read from the memory, the other DMA circuit can acquire the data and can transfer the data to another address of the memory or transfer the data to input/output apparatuses.

This Nonprovisional application claims priority under 35 U.S.C. §119(a) on Patent Application No. 2006-044846 filed in JAPAN on Feb. 22, 2006, the entire contents of which are hereby incorporated herein by references.

### FIELD OF THE INVENTION

The present invention relates to a data processing apparatus that can transfer data in a direct memory access mode.

### BACKGROUND OF THE INVENTION

With regard to a data processing apparatus mounted to a composite apparatus that integrates a copier, a scanner, a printer, and a facsimile machine and processing image data, recently, since colorization is increasingly supported and faster data processing is required, the data processing is accelerated by data transfer in a direct memory access (abbreviated to DMA) mode.

A conventional art for above data processing apparatus includes that shown in FIG. 1, for example. This conventional data processing apparatus includes a CPU 1 that is a main controlling unit, a memory 2, and three internal blocks 3 (3a, 3b, 3c). Each internal block 3 includes a register 4, a DMA circuit 5 that is a memory processing unit, and a control circuit 6.

FIG. 2 is an explanatory flowchart of DMA-related operation of the CPU 1. In FIG. 1, each register 4 is provided with a setting condition from the CPU 1. The DMA circuit 5 performs at least one of data write into the memory 2 and data read from the memory 2 based on the setting condition stored in the register 4. The DMA circuit 5 is activated in response to an activation instruction from the CPU 1. When completing at least one of data write into the memory 2 and data read from the memory 2, the DMA circuit 5 provides an interruption request for the CPU 1.

In such a data processing apparatus, every time each DMA circuit 5 completes at least one of data write into the memory 2 and data read from the memory 2, each DMA circuit 5 provides an interruption request for the CPU 1. When the CPU 1 is provided with the interruption request, the CPU 1 performs register setting for the DMA circuit 5 that should be activated next and provides the activation instruction for the DMA circuit 5. As a result, the DMA circuits 5 are sequentially activated.

In the case of the above conventional data processing apparatus, when the DMA circuits 5 are sequentially activated, each DMA circuit 5 provides the interruption request for the CPU 1 every time at least one of the data write into the memory 2 and the data read from the memory 2 is completed, and when the CPU 1 is provided with the interruption request, the CPU 1 must perform the register setting for the DMA circuit 5 that should be activated next and provide the activation instruction for the DMA circuit 5. Therefore, it is problematic that processing load of the CPU is generated and that the performance of the CPU is deteriorated.

To solve such a problem, the applicant has been proposed a data processing apparatus shown in Japanese Laid-Open Patent Publication No. 2006-172107.

FIG. 3 is a simplified block diagram of a data processing apparatus shown in Japanese Laid-Open Patent Publication No. 2006-172107. The data processing apparatus can perform at least one of data write into a memory 2 and data read from a memory 2 in the DMA mode without intervention of a CPU 1 and includes a CPU 1, a memory 2, a plurality of (in the example of FIG. 3, three of 11a, 11b and 11c) DMA circuits 11, and a plurality of (in this embodiment, three of 12a, 12b and 12c) selector circuits 12.

The DMA circuits 11 (11a, 11b and 11c) are memory processing units and access the common memory 2. Each DMA circuit 11 performs the data write into the memory 2 and the data read from the memory 2 and outputs an end notification when at least one of the writing and the reading is completed. In response to an activation instruction from each selector circuit 12 (12a, 12b and 12c), each DMA circuit 11 starts at least one of the data write into the memory 2 and the data read from the memory 2.

The CPU 1 outputs start instructions of the data write into the memory 2 and the data read from the memory 2. The CPU 1 outputs a selection instruction indicating whether the start instruction from the CPU 1 or the end notification from each DMA circuit 11 is selected. Each selector circuit 12 outputs the activation instruction in response to the start instruction from the CPU 1 or the end notification from each DMA circuit 11. Each selector circuit 12 responds to the start instruction from the CPU 1 or the end notification from each DMA circuit 11 depending on the selection instruction from the CPU.

FIG. 4 is an explanatory diagram of an example of the data write into the memory 2 and the data read from the memory 2 by the DMA circuits 11a, 11b and 11c. A first DMA circuit 11a is set so as to write data into the memory 2; a start address is set to an address A; and the number of transferred bytes is set to N bytes. A second DMA circuit 11b is set so as to read data from the memory 2; a start address is set to the address A; and the number of transferred bytes is set to N bytes. A third DMA circuit 11c is set so as to write data into the memory 2; a start address is set to an address B; and the number of transferred bytes is set to M bytes.

With regard to the selectors 12a, 12b and 12c, a first selector circuit 12a is set so as to output the activation instruction in response to the start instruction from the CPU 1. A second selector circuit 12b is set so as to output the activation instruction in response to the end notification from the first DMA circuit 11a. A third selector circuit 12c is set so as to output the activation instruction in response to the end notification from the second DMA circuit 11b.

When the DMA circuits 11 and the selector circuits 12 are set in this way, if the CPU 1 outputs the start instruction, the first selector circuit 12a outputs the activation instruction in response to the start instruction from the CPU 1. The first DMA circuit 11a is activated in response to the activation instruction from the first selector circuit 12a and writes data into the memory 2. The data are sequentially written into the memory 2 from the address A for N bytes. When completing the data write into the memory 2, the first DMA circuit 11a outputs the end notification.

The second selector circuit 12b outputs the activation instruction in response to the end notification from the first DMA circuit 11a. The second DMA circuit 11b is activated in response to the activation instruction from the second selector circuit 12b and read the data from the memory 2. The data are sequentially read from the memory 2 from the address A for N bytes. When completing the data read from the memory 2, the second DMA circuit 11b outputs the end notification.

The third selector circuit 12c outputs the activation instruction in response to the end notification from the second DMA circuit 11b. The third DMA circuit 11c is activated in response to the activation instruction from the third selector circuit 12c and writes data into the memory 2. The data are sequentially written into the memory 2 from the address B for M bytes.

FIG. 5 is a block diagram of an overall configuration of the data processing apparatus and FIG. 6 is a block diagram of details of internal block 13a shown in FIG. 5. The data processing apparatus includes a memory 2, a memory controller 9 that controls the memory 2, an arbiter and selector 8, a plurality of (in the example shown, three) internal blocks 13 (13a to 13c) described later, and a CPU 1. The arbiter and selector 8 lies between the memory controller 9 and the internal blocks 13, selects one of the internal blocks 13 (13a to 13c), and allocates the bus use right to the selected internal block.

The internal block 13 includes a register 14, a DMA circuit 15, a selector circuit 16 and a control circuit 17, and the DMA circuit 15 can control the memory controller 9 through the arbiter and selector 8 to perform at least one of the data write into the memory 2 and the data read from the memory 2 and has any one of a function of scan input, a function for compression to input and extension to output, a function for rotation input/output, and a function for laser output, for example.

The CPU 1 provides a CPU address CPU_ADR and CPU data CPU_DATA for the register 14. The CPU address CPU_ADR indicates the address of the register 14, and the CPU data CPU_DATA indicate the setting conditions of the control circuit 17, the DMA circuit 15, and the selector circuit 16. The CPU 1 is provided with CPU data CPU_DATA from the register 14. The CPU data CPU_DATA indicate the statuses of the control circuit 17, the DMA circuit 15 and the selector circuit 16.

The register 14 decodes the CPU address CPU_ADR and latches the CPU data CPU_DATA at the address specified by the CPU address CPU_ADR at the time of writing. The register 14 transfers the CPU data CPU_DATA from the address specified by the CPU address CPU_ADR at the time of reading.

The control circuit 17 calculates data based on the setting condition of the control circuit 17 stored in the register 14. The control circuit 17 provides the status of the control circuit 17 for the register 14. The control circuit 17 controls an input/output apparatus 10. The control circuit 17 provides data for the input/output apparatus 10. The control circuit 17 includes a buffer circuit that stores data and is provided with data from the input/output apparatus 10.

For example, if a first internal block 13a is an internal block with a function for scan input, the control circuit 17 includes a timing generation circuit and a buffer circuit. The timing generation circuit generates timing of reading scan data read from a document by an image reading unit that is the input/output apparatus 10. The buffer circuit stores the scan data.

The DMA circuit 15 transfers data based on the setting condition of the DMA circuit 15 stored in the register 14. The setting condition of the DMA circuit 15 indicates a start address and a number of transferred bytes. The DMA circuit 15 provides the status of the DMA circuit 15 for the register 14. The DMA circuit 15 is activated in response to an activation instruction D_TRG1 from the selector circuit described later. The DMA circuit 15 reads data stored in the buffer circuit within the control circuit 17 and writes the data into the memory 2. Alternatively, the DMA circuit 15 reads data stored in the memory 2 and writes the data into the buffer circuit within the control circuit 17.

Specifically, the DMA circuit 15 provides a DMA address DMA_ADR1 through an arbiter and selector 8 for a memory controller 9. The DMA address DMA_ADR1 indicates the address of the memory 2. The DMA circuit 15 provides a DMA control signal DMA_CONT1 through the arbiter and selector 8 for the memory controller 9. This DMA control signal DMA_CONT1 indicates an instruction for writing into the memory 2 and an instruction for reading from the memory 2. The DMA circuit 15 is provided with a DMA control signal DMA_CONT1 through the arbiter and selector 8 from the memory controller 9. This DMA control signal DMA_CONT1 indicates the status of the memory controller 9.

The DMA circuit 15 specifies the address of the memory 2 with the DMA address DMA_ADR1. The DMA circuit 15 instructs at least one of the writing and the reading with the DMA control signal DMA_CONT1. In this way, the DMA circuit 15 can perform at least one of the data write into the specified address of the memory 2 and the data read from the specified address of the memory 2. The data correspond to DMA data DMA_DATA of FIG. 6.

When completing at least one of the data write into the memory 2 and the data read from the memory 2, the DMA circuit 15 outputs an end notification DMA_END1 and outputs an interruption request INTR1. The setting condition of the DMA circuit 15 also indicates whether the interruption request INTR1 is masked. When the interruption request INTR1 is masked, the DMA circuit 15 does not output the interruption request INTR1 if at least one of the writing and the reading is completed.

The interruption request INTR1 is provided for the OR circuit 7. The OR circuit 7 is provided with the interruption requests INTR1 to INTR3 from the DMA circuit 15 of each internal block 13. When any one of the interruption requests INTR1 to INTR3 is provided, the OR circuit 7 outputs an interruption request INTR. The interruption request INTR is provided for the CPU 1.

The selector circuit 16 outputs an activation instruction based on a selection instruction that is the setting condition of the selector circuit 16 stored in the register 14. The selector circuit 16 outputs an activation instruction D_TRG1 in response to any one of a start instruction DMA_TRG1 provided through the register 14 from the CPU 1 and end notifications DMA_END2, DMA_END3 from the DMA circuits 15 of second and third internal blocks 13b, 13c.

FIG. 7 is an explanatory flowchart of DMA-related operation of the CPU 1. In FIG. 7, it is assumed that the DMA circuits 15 are activated in the order of a first DMA circuit 15a, a second DMA circuit 15b, and a third DMA circuit 15c.

When a predetermined operation start instruction is input, the CPU 1 starts the DMA-related operation, provides the setting condition of the control circuit 17 of each internal block 13 for the register 14 of each internal block 13 to perform the register setting for the control circuit 17 of each internal block 13 at step S11, and goes to step S12.

At step S12, the setting condition of the first DMA circuit 15a is provided for the register 14 of the first internal block 13a to perform the register setting for the first DMA circuit 15a; at step S13, the setting condition of the second DMA circuit 15b is provided for the register 14 of the second internal block 13b to perform the register setting for the second DMA circuit 15b; and at step S14, the setting condition of the third DMA circuit 15c is provided for the register 14 of the third internal block 13c to perform the register setting for the third DMA circuit 15c. At these steps S12 to S14, the setting is performed for the start address, the number of transferred bytes, etc.

At step S15, the register 14 of each internal block 13 is provided with a selection instruction that is the setting condition of each selector circuit 16, and the procedure goes to step S16. In FIG. 6, the register 14 of the first internal block 13a is provided with the selection instruction indicating that the start instruction from the CPU 1 is selected. The register 14 of the second internal block 13b is provided with the selection instruction indicating that the end notification from the first DMA circuit 15a is selected. The register 14 of the third internal block 13c is provided with the selection instruction indicating that the end notification from the second DMA circuit 15b is selected. By providing the selection instructions for the registers 14 of the internal blocks 13, the CPU 1 performs coordination setting for coordinating the DMA circuits 15.

At step S16, the setting is performed for the registers 14 of the internal blocks 13 to mask unnecessary interruption requests and the procedure goes to step S17. The unnecessary interruption requests are interruption requests from the remaining DMA circuits 15 except the DMA circuit 15 activated lastly among the DMA circuits 15 that should be activated. In FIG. 6, the interruption requests from the first and second DMA circuits 15a, 15b are masked.

At step S17, the start instruction is output to set the start bit of the first DMA circuit 15a, and the procedure goes to step S18. At step S18, the DMA-related operation is terminated when the interruption request from the DMA circuit 15 is provided, which is the interruption request from the third DMA circuit 15c in FIG. 7.

When the CPU 1 outputs the start instruction at step S17, the first selector circuit 16a outputs an activation instruction in response to the start instruction from the CPU 1. The first DMA circuit 15a is activated in response to the activation instruction from the first selector circuit 16a. In response to the end notification from the first DMA circuit 15a, the second selector circuit 16b outputs an activation instruction. The second DMA circuit 15b is activated in response to the activation instruction from the second selector circuit 16b. In response to the end notification from the second DMA circuit 15b, the third selector circuit 16c outputs an activation instruction. The third DMA circuit 15c is activated in response to the activation instruction from the third selector circuit 16c. When completing at least one of the data write into the memory 2 and the data read from the memory 2, the third DMA circuit 15c outputs an interruption request. The interruption request is provided for the OR circuit 7. The OR circuit 7 provides the interruption request for the CPU 1.

During the period after the CPU 1 outputs the start instruction and until the CPU 1 is provided with the interruption request, each DMA circuit 15 can write data into the memory and read data from the memory without intervention of the CPU 1. In this period, the CPU 1 can perform another process.

In the above prior art, each selector circuit 16 can output the activation instruction in response not only to the start instruction from the CPU 1 but also to the end notification from each DMA circuit 15. Therefore, if any one of the selector circuits 16 is provided with the start instruction from the CPU 1, the selector circuits 16 can sequentially activate the DMA circuits 15 even when other selector circuits 16 are not provided with the start instruction from the CPU 1.

In other words, the DMA circuits 15 can be coordinated without intervention of the CPU 1. Therefore, since each DMA circuit may not provide the interruption request for the CPU to output the start instruction from the CPU every time each DMA circuit completes at least one of the data write into the memory and the data read from the memory as in the case of the previous conventional arts, the processing load of the CPU can be reduced, and the performance deterioration of the CPU can be prevented.

However, if a plurality of process blocks performs a series of processes for the same data, the next DMA cannot start operation unless the reading or writing of one DMA is completed even when it is preliminary known as a process procedure that a plurality of the process blocks reads data at the same address or that data written by one process block is read by another process block in the above prior art, which limits further speeding-up.

In one prior art enabling a plurality of DMA devices to read data on the same address of the memory at the same time, when it is detected that a plurality of the DMA devices connected to different I/O buses attempts to read data at the same memory address, this is performed by using a bridge that transfers data from the memory bus to a plurality of I/O buses (Japanese Laid-Open Patent Publication No. H11-134287). However, this conventional art is performed only when it is detected that the DMA devices coincidentally attempt to read the data at the same address and is difficult to apply when data processing speeds are different in the destinations of the transfer after the reading.

### SUMMARY OF THE INVENTION

The object of the present invention is to provide a data processing apparatus that can further speed up data processing and efficiently use a memory bus by enabling other DMA circuits to acquire the same data if it is preliminary known as a process procedure that a plurality of process blocks reads data at the same address or that data written by one process block is read by another process block, even when a plurality of process blocks has different processing speeds.

Another object of the present invention is to provide a data processing apparatus comprising: a memory that allows data write and data read; a main controlling unit that outputs start instructions of the data write into the memory and the data read from the memory; a plurality of DMA circuits that performs at least one of the data write into the memory and the data read from the memory to output an end notification when completing at least one of the data write into the memory and the data read from the memory; and a plurality of activation instructing units that outputs an activation instruction for activating each of the DMA circuits, the activation instructing units outputting the activation instructions in response to the start instruction from the main controlling unit or the end notifications from the DMA circuits, the DMA circuits being activated in response to the activation instructions from the activation instructing units, the data processing apparatus having a parallel-group forming circuit for forming a parallel group of any two or more DMA circuits of the DMA circuits based on the instruction from the main controlling unit, the parallel-group forming circuit allowing data processed in a write process or read process of one DMA circuit to be acquired by the other DMA circuit.

Another object of the present invention is to provide a data processing apparatus, wherein one of the DMA circuits formed into the parallel group by the parallel-group forming circuit is set to be a master and the other is set to be a slave and wherein a signal line is disabled in the DMA circuit set to be the slave.

Another object of the present invention is to provide a data processing apparatus, wherein a DMA group is formed and serially coordinated by integrating the activation/end signals output by the DMA circuits and wherein interruption requests are disabled except that of the last DMA circuit.

Another object of the present invention is to provide a data processing apparatus, wherein the other DMA circuit provides the end notification for one DMA circuit every time the data process is completed and wherein one DMA circuit is set so as not to perform the next burst access operation unless the end notification is provided by the other DMA circuit.

Another object of the present invention is to provide a data processing apparatus, wherein a predetermined DMA circuit among the DMA circuits is set to select one requiring the longest data process time in a data process block.

Another object of the present invention is to provide a data processing apparatus, wherein the parallel-group forming circuit connects memory data lines and command signal lines of one DMA circuit and the other DMA circuit based on the instruction from the main controlling unit.

Another object of the present invention is to provide a data processing apparatus, wherein the parallel-group forming circuit disposes selectors on the DMA circuits and allows a data bus to be used in common to make a necessary DMA circuit active based on the instruction from the main controlling unit.

Another object of the present invention is to provide a data processing apparatus, wherein the parallel-group forming circuit connects control signal lines on the input/output apparatus side corresponding to the DMA circuits.

### BRIEF DESCRIPTION OF THE DRAWINGS

FIG. 1 is a block diagram of a configuration of a data processing apparatus of a conventional art;

FIG. 2 is a flowchart of DMA-related operation of a CPU in a conventional art;

FIG. 3 is a simplified block diagram of a data processing apparatus in a prior art of the present invention;

FIG. 4 is an explanatory diagram of an example of data write into a memory and data read from a memory by a DMA circuit;

FIG. 5 is a block diagram of an overall configuration of the data processing apparatus in the prior art of the present invention;

FIG. 6 is a block diagram of an internal block configuration of the data processing apparatus in the prior art of the present invention;

FIG. 7 is an explanatory flowchart of DMA-related operation of a CPU of the data processing apparatus in the prior art of the present invention;

FIG. 8 is a simplified block diagram of a data processing apparatus according to one embodiment of the present invention;

FIG. 9 is a block diagram of an overall configuration of the data processing apparatus;

FIG. 10 depicts a configuration of a relevant part of the data processing apparatus;

FIG. 11 is an explanatory flowchart of DMA-related operation of a CPU and operation of a DMA; and

FIG. 12 depicts a configuration of a relevant part of a data processing apparatus according to another embodiment of the present invention.

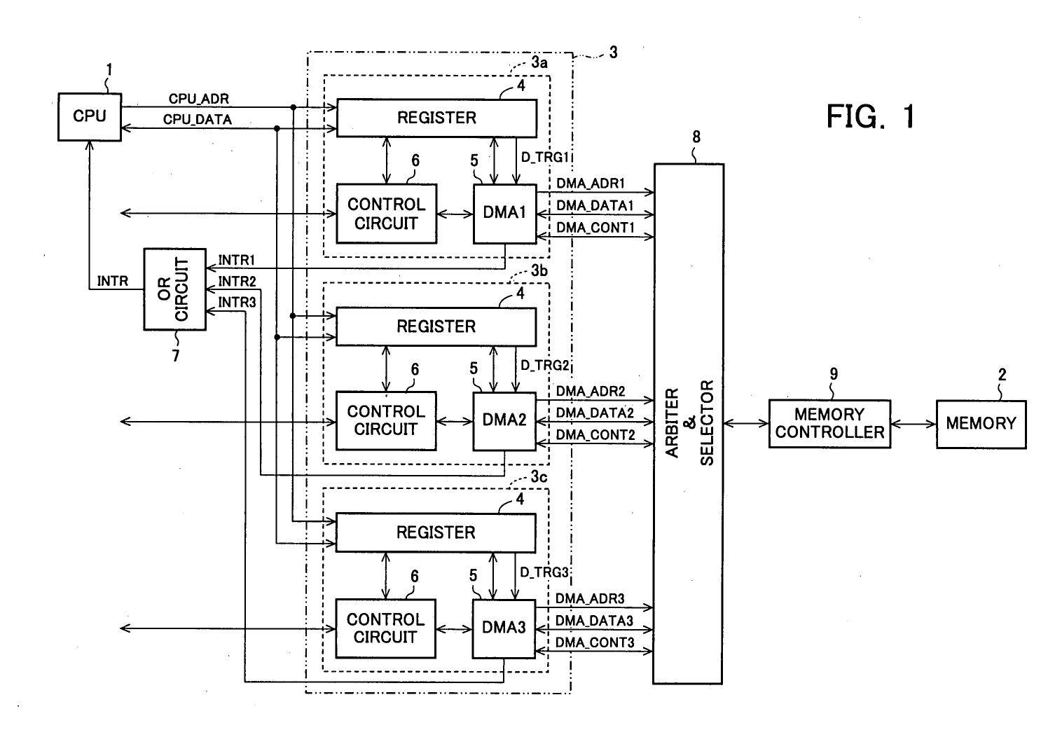

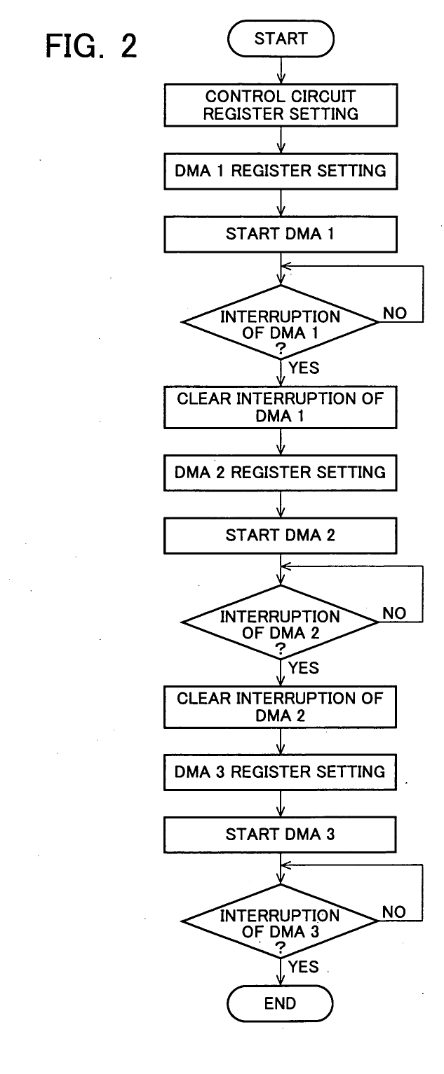

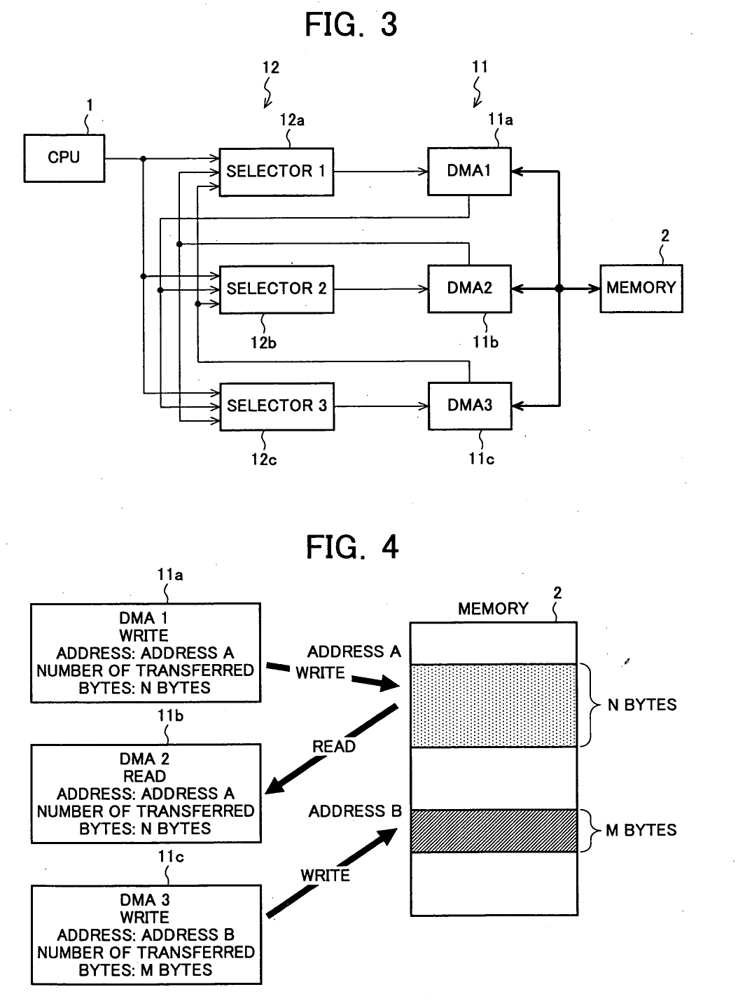

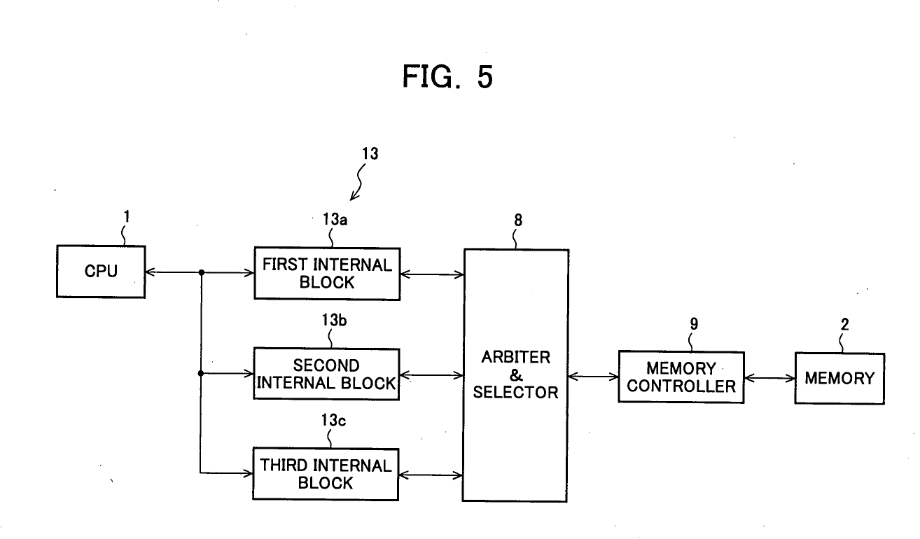

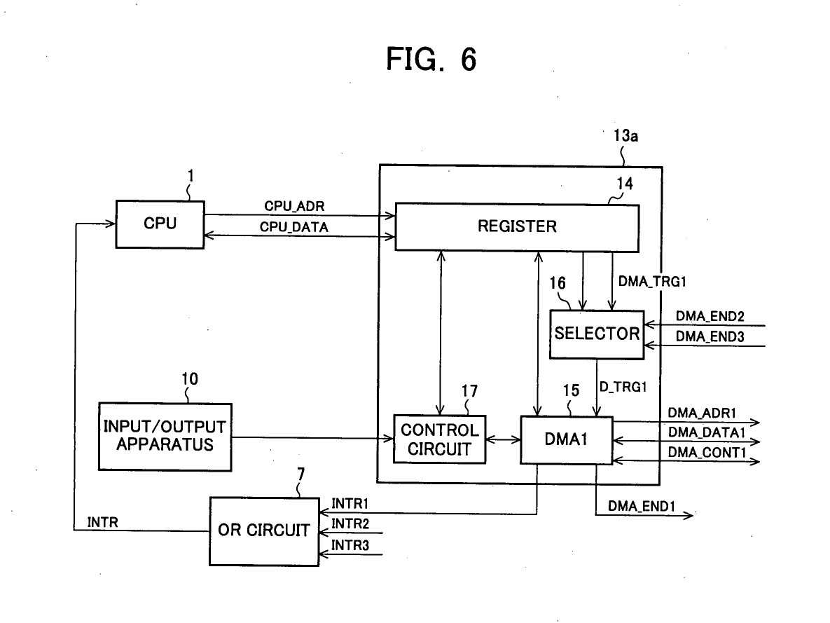

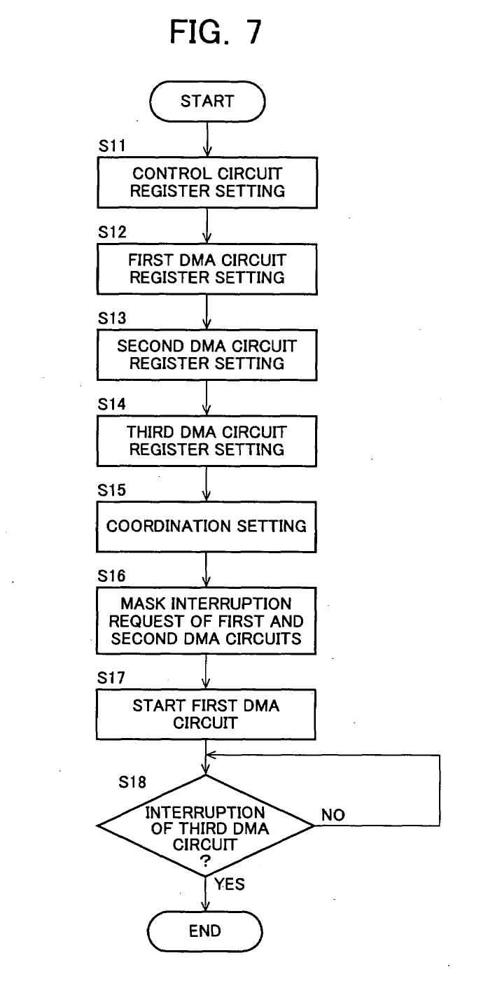

### PREFERRED EMBODIMENT OF THE INVENTION

The present invention will now be described with reference to the drawings. The same portions as the above prior art will not be described.

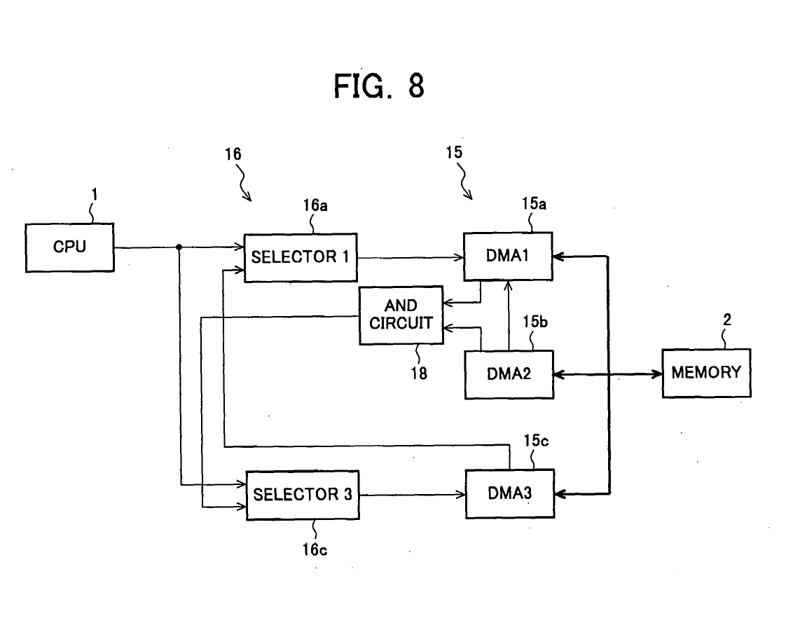

FIG. 8 is a simplified block diagram of a data processing apparatus according to one embodiment of the present invention. A data processing apparatus according to the present invention includes a CPU 1, a memory 2, a plurality of DMA circuits 15 (15a to 15c), and a plurality of selector circuits 16 (16a, 16c). The DMA circuits 15 will sometimes be referred to as first to third DMA circuits 15a to 15c. The selector circuits 16 will sometimes be referred to as first to third selector circuits 16a to 16c.

An embodiment of FIG. 8 shows an example of grouping two DMA circuits 15a, 15b out of three DMA circuits and shows that when end signals are output from the first DMA circuit 15a and the second DMA circuit 15b, an activation signal is input from the third selector circuit 16c to the third DMA circuit 15c due to an output signal of an AND circuit 18, that when the process in the third DMA circuit 15c is completed, an end signal is input to the first selector circuit 16a, and that a start signal of the next process block is input to the first DMA circuit 15a.

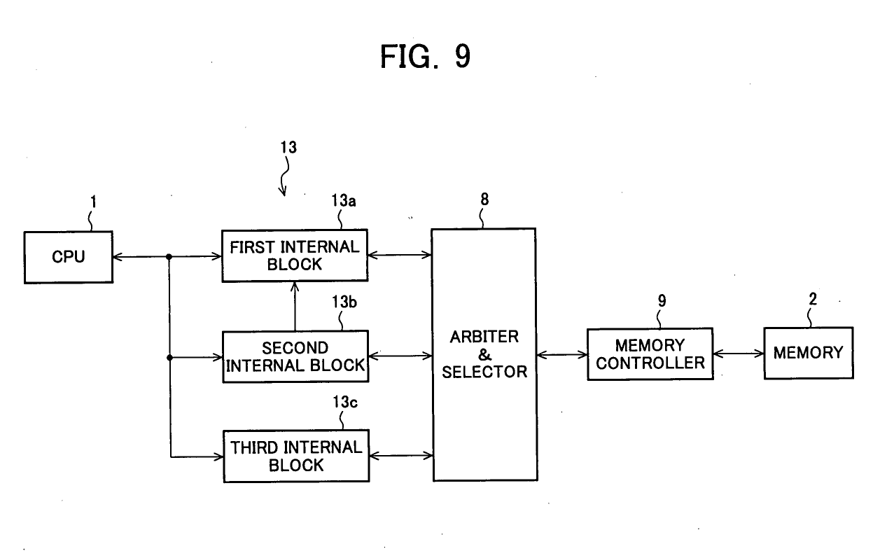

FIG. 9 is a block diagram of an overall configuration of the data processing apparatus according to the embodiment. The data processing apparatus includes the CPU 1, the memory 2, a plurality of (in the example shown, three) internal blocks 13 (13a to 13c) including the DMA circuit, a memory controller 9 that controls the memory 2, and an arbiter and selector 8, and the first internal block 13a and the second internal block 13b are grouped.

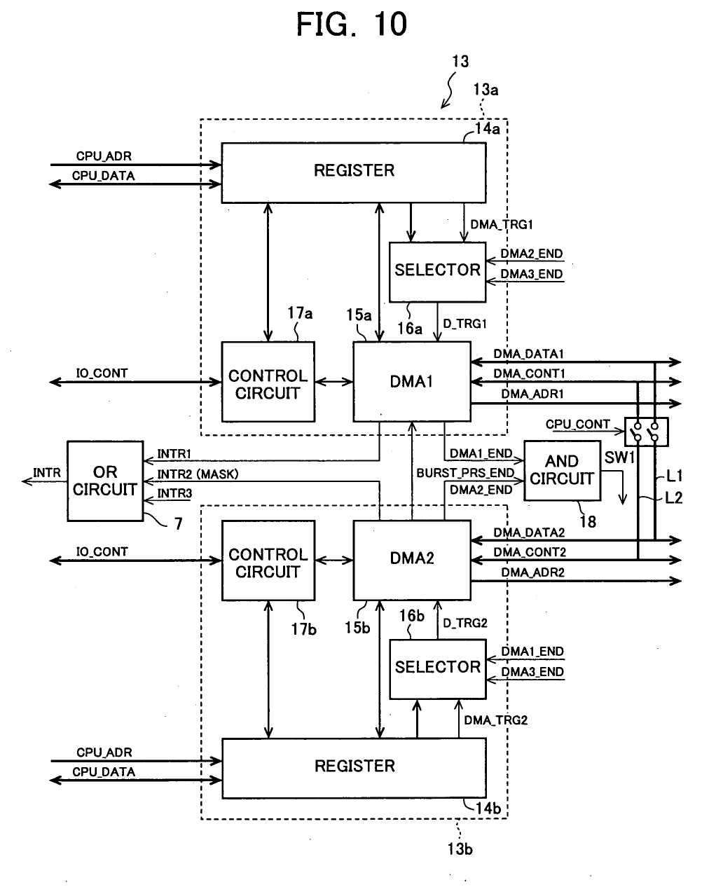

FIG. 10 depicts details of a relevant part of the data processing apparatus according to the embodiment. In the example of FIG. 10, when writing/reading data into/from the memory, the first DMA circuit 15a and the second DMA circuit 15b can perform parallel processing at the same time, and the memory data line and command signal line of the first DMA circuit 15a are connected to the memory data line and command signal line of the second DMA circuit 15b through connection lines L1, L2 via switch SW 1 operated depending on a control signal CPU_CONT from the CPU.

In another way to form a parallel group of the DMA circuits, for example, the DMAs may use the same bus and may provided with a chip select for making a necessary DMA active. That is, the similar operation can be performed by making the DMAs active one-by-one when operated individually and by making a plurality of the grouped DMAs active when operated in parallel.

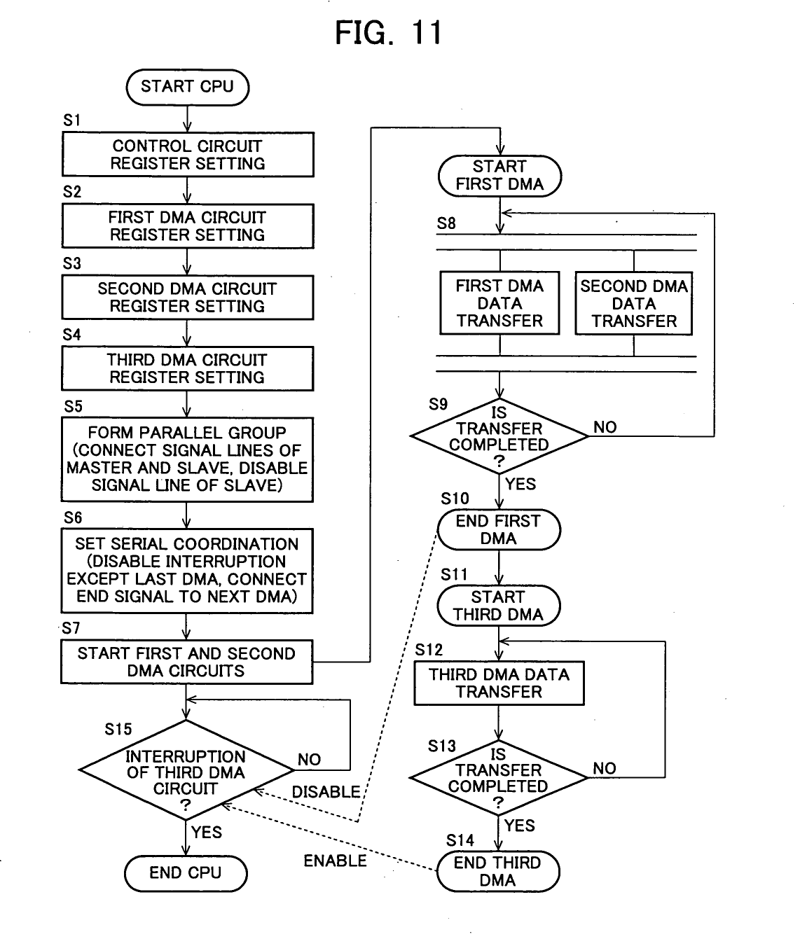

FIG. 11 is an explanatory flowchart of the DMA-related operation of the CPU 1 and the operation of the DMA. When a predetermined operation start instruction is input, the CPU 1 starts the DMA-related operation, provides a setting condition of a control circuit 17 of each internal block 13 for a register 14 of each internal block 13 to perform the register setting for the control circuit 17 of each internal block 13 at step S1.

At step S2, the setting condition of the first DMA circuit 15a is provided for the register 14 of the first internal block 13a to perform the register setting for the first DMA circuit 15a; at step S3, the setting condition of the second DMA circuit 15b is provided for the register 14 of the second internal block 13b to perform the register setting for the second DMA circuit 15b; and at step S4, the setting condition of the third DMA circuit 15c is provided for the register 14 of the third internal block 13c to perform the register setting for the third DMA circuit 15c. At these steps S2 to S4, the setting is performed for the start address, the number of transferred bytes, etc.

At step S5, the switch SW1 is closed by a control signal CPU_CONT from the CPU 1 to connect the memory data lines and the command signal lines of the first DMA circuit 15a and the second DMA circuit 15b through the connection lines L1, L2, and the first DMA circuit 15a and the second DMA circuit 15b are grouped in parallel by setting any one DMA circuit as a master and the other DMA circuit as a slave. At step S5, the setting is performed to mask the interruption request of the second DMA circuit 15b.

At step S6, the CPU 1 provides a selection instruction that is a setting condition of each selector circuit 16 for the register 14 of each internal block 13. In FIG. 10, the register 14a of the first internal block 13a and the register 14b of the second internal block 13b are provided with the selection instruction indicating that the start instruction from the CPU 1 is selected.

Although not shown in FIG. 10, the register 14c of the third internal block 13c is provided with the selection instruction indicating that the end notification is selected which is output from the AND circuit 18 due to the end signals from the first DMA circuit 15a and the second DMA circuit 15b. By providing the selection instructions for the registers 14 of the internal blocks 13, the CPU 1 performs coordination setting for coordinating the DMA circuits 15.

At step S6, the CPU 1 also performs the setting for the registers 14 of the internal blocks 13 to mask unnecessary interruption requests. The unnecessary interruption requests are interruption requests from the DMA circuits except the DMA circuit activated lastly among the DMA circuits 15 that should be activated. In FIG. 10, the interruption requests from the first and second DMA circuits 15a, 15b are masked. The interruption request is provided for an OR circuit 7 and the OR circuit 7 provides the interruption request for the CPU 1.

At step S6, if the first DMA circuit 15a is preliminarily set to select one requiring the longest process time in the group, for example, an image data capturing process of a scanner, etc., the first DMA circuit 15a can perform the burst access operation without the need for the end notification from the second DMA circuit 15b. That is, if it is ensured that the process time of the second DMA circuit 15b is always shorter than the process time of the first DMA circuit 15a, the second DMA circuit 15b does not have to send the end notification to the first DMA circuit 15a every time the data processing is completed.

At step S7, the CPU 1 outputs the start instruction to set the start bits of the first DMA circuit 15a and the second DMA circuit 15b; at step S8, the first DMA circuit 15a and the second DMA circuit 15b perform data transfer; and when the data transfer is completed (step S9), the first DMA circuit 15a outputs the end notification at step S10.

At step S11, the third DMA circuit 15c is started by the end notification from the first DMA circuit 15a; at step S12, the third DMA circuit 15c performs data transfer; and when the data transfer is completed (step S13), the third DMA circuit 15c outputs the end notification at step S14.

At step S15, the CPU 1 is provided with the interruption request from the third DMA circuit 15c, i.e., the last DMA circuit, the DMA-related operation is completed.

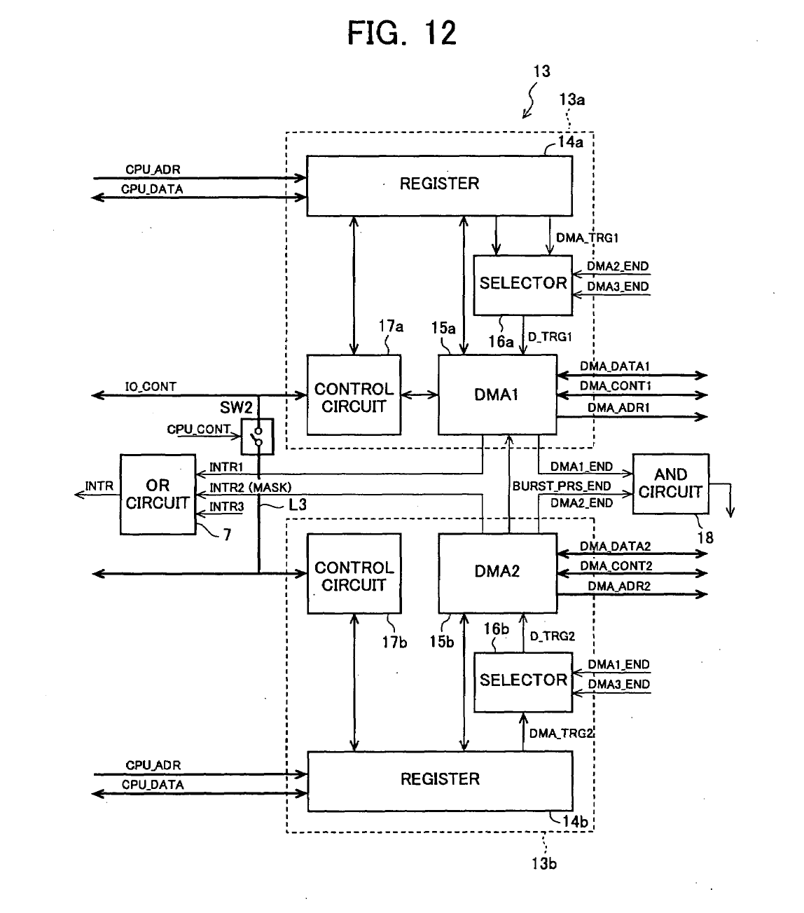

FIG. 12 depicts another embodiment of the present invention, where a switch SW2 is disposed on the input/output side corresponding to the DMA circuits such that the signal lines can be connected. In the case of such a configuration, a plurality of the DMA circuits can share data even when input/output apparatus 10 gives and receives data.

During the period after the CPU 1 outputs the start instruction and until the CPU 1 is provided with the interruption request, while the first DMA circuit 15a writes data into the memory or reads data from the memory, the second DMA circuit 15b can concurrently acquire the data to be written into the memory 2 or the data read from the memory 2 by the first DMA circuit 15a, and can write the data into the memory 2 at another address or transfer the data to a buffer of a control circuit 17b without intervention of the CPU 1.

Therefore, the same data are concurrently utilized; the read operation is reduced to use the memory bus efficiently; and the number of the DMAs can be reduced from the viewpoint of the CPU.

According to the present invention, since a plurality of the DMA circuits handles the dame data, the data processing can further be accelerated and the memory bus can efficiently be used.

The number of the DMA circuits can be reduced from the viewpoint of the CPU.

Further, the data processing can be completed in the DMA group without affecting the processing speed of each DMA and without omission.

1. A data processing apparatus comprising:
a memory that allows data write and data read;
a main controlling unit that outputs start instructions of the data write into the memory and the data read from the memory;
a plurality of DMA circuits that performs at least one of the data write into the memory and the data read from the memory to output an end notification when completing at least one of the data write into the memory and the data read from the memory; and
a plurality of activation instructing units that outputs an activation instruction for activating each of the DMA circuits, the activation instructing units outputting the activation instructions in response to the start instruction from the main controlling unit or the end notifications from the DMA circuits, the DMA circuits being activated in response to the activation instructions from the activation instructing units,
the data processing apparatus having a parallel-group forming circuit for forming a parallel group of any two or more DMA circuits of the DMA circuits based on the instruction from the main controlling unit, the parallel-group forming circuit allowing data processed in a write process or read process of one DMA circuit to be acquired by the other DMA circuit.

2. The data processing apparatus as defined in claim 1, wherein one of the DMA circuits formed into the parallel group by the parallel-group forming circuit is set to be a master and the other is set to be a slave and wherein a signal line is disabled in the DMA circuit set to be the slave.

3. The data processing apparatus as defined in claim 2, wherein a DMA group is formed and serially coordinated by integrating the activation/end signals output by the DMA circuits and wherein interruption requests are disabled except that of the last DMA circuit.

4. The data processing apparatus as defined in claim 2 or 3, wherein the other DMA circuit provides the end notification for one DMA circuit every time the data process is completed and wherein one DMA circuit is set so as not to perform the next burst access operation unless the end notification is provided by the other DMA circuit.

5. The data processing apparatus as defined in claim 2 or 3, wherein a predetermined DMA circuit among the DMA circuits is set to select one requiring the longest data process time in a data process block.

6. The data processing apparatus as defined in claim 1 or 2, wherein the parallel-group forming circuit connects memory data lines and command signal lines of one DMA circuit and the other DMA circuit based on the instruction from the main controlling unit.

7. The data processing apparatus as defined in claim 1 or 2, wherein the parallel-group forming circuit disposes selectors on the DMA circuits and allows a data bus to be used in common to make a necessary DMA circuit active based on the instruction from the main controlling unit.

8. The data processing apparatus as defined in claim 1, wherein the parallel-group forming circuit connects control signal lines on the input/output apparatus side corresponding to the DMA circuits.
